(19) United States
(12) Patent Application Publication
(10) Pub. No.: US 2026/0100757 A1
(43) Pub. Date: Apr. 9, 2026

(54) ENABLING COMMUNICATION OF MULTI-MEDIA MESSAGES DURING BIDIRECTIONAL TESTING OF A COMMUNICATION LINK UNDER TEST (LUT)

(71) Applicant: VIAVI SOLUTIONS INC., Chandler, AZ (US)

(72) Inventors: Andre CHAMPAVERE, Saint-Bonnet les Oules (FR); Jonathan ROUX, Toussieu (FR)

(73) Assignee: VIAVI SOLUTIONS INC., Chandler, AZ (US)

(21) Appl. No.: 18/908,263

(22) Filed: Oct. 7, 2024

(51) Int. Cl. H04B 10/071

(52) U.S. Cl. CPC H04B 10/071

(57) ABSTRACT

According to examples, systems and methods for communicating during bidirectional testing of a fiber optic link under test (LUT) are provided. This may include initiating a bidirectional measurement of the LUT, including initiating a first acquisition by a first optical time domain reflectometer (OTDR), receiving a request, prior to completion of the bidirectional measurement of the LUT, to send a multimedia message over the LUT during the bidirectional measurement of the LUT, and receiving information related to the multimedia message to be sent. In addition, this may include preparing the multimedia message to be sent over the LUT, determining a time slot during the bidirectional measurement of the LUT to send the multimedia message, and sending the multimedia message during the time slot over the LUT to a second OTDR.

### TECHNICAL FIELD

This patent application relates generally to testing of communication networks, and more specifically, to enabling communication of multi-media messages during bidirectional testing of communication links (e.g., fiber optic links) under test (LUT).

### BACKGROUND

A fiber optic communication network may include one or more optical components. Examples may include optical connectors, optical splices, optical couplers, and optical switches. These optical components may be coupled via use of one or more fiber optic cables. A fiber optic cable may include one or more optical fibers to transmit optical signals from a source to a destination.

In some instances, it may be necessary to test components and cables of a fiber optic communication network to ensure proper operation. Testing may be performed prior to installation or during operation.

It may be appreciated that, in between or after generation of results of such testing, those administering the testing (e.g., service technicians) may wish to communicate information related to the tests. However, in certain environments, like data centers where personal devices (e.g., smartphones) may not be permitted, such communication may be difficult or unavailable.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a system implementing bidirectional reflectometry testing between two optical time-domain reflectometers (OTDRs), according to an example.

FIG. 2 illustrates a timespan over which time division multiplexing (TDM) may enable bi-directional measurement and exchange of data between two OTDRs, according to an example.

FIG. 3 illustrates a system implementing a bidirectional reflectometry testing carried over a multi-fiber cable, according to an example.

FIG. 4 illustrates a system implementing a bidirectional reflectometry testing including a dedicated link for voice messaging, according to an example.

FIG. 5 illustrates a timespan over which TDM may enable bi-directional measurement and exchange of multimedia content between two OTDRs, according to an example.

FIG. 6 illustrates aspects of an OTDR device configured to utilizing TDM to enable bi-directional measurement and exchange of multimedia content, according to an example.

FIGS. 7A-7B illustrates a pair of user interfaces (UIs) of an OTDR device directed to bi-directional measurement and exchange of multimedia content, according to an example.

FIG. 8 illustrates a system including a pair of OTDRs configured to utilizing TDM to enable bi-directional measurement and exchange of multimedia content, according to an example.

FIG. 9 illustrates a timespan over which TDM and wavelength division multiplexing (WDM) enable bi-directional measurement and exchange of multimedia content, according to an example.

FIG. 10 illustrates a system including a pair of OTDRs utilizing TDM and WDM to enable bi-directional measurement and exchange of multimedia content over an FUT, according to an example.

FIG. 11 illustrates aspects of an OTDR device configured to utilizing TDM and WDM to enable bi-directional measurement and exchange of multimedia content, according to an example.

FIG. 12 provides proposed wavelength pairs that may be implemented to enable bi-directional measurement and exchange of multimedia content, according to an example.

### DETAILED DESCRIPTION

For simplicity and illustrative purposes, the present application is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to de at least one of a particular element. As used herein, the term “includes” means includes but not limited to, the term “including” means including but not limited to. The term “based on” means based at least in part on.

Data centers enable sharing of data and content and provide storage and backup for redundancy, and typically house compute and storage resources for applications, data, and content. A data center typically includes various electronic equipment to support network communication(s), including optical components. Examples of such optical components may include optical connectors, optical splices, optical couplers, and optical switches.

These optical components may be coupled via use of one or more fiber optic cables. Typically, a fiber optic cable may include one or more optical fibers that may be used to transmit optical signals from a source to a destination.

In some instances, it may be necessary to test cables and/or components of a communication network to ensure proper operation. Testing may be performed prior to installation or during operation.

An optical time-domain reflectometer (OTDR) is an optoelectronic instrument used to characterize an optical fiber. In some instances, the fiber may interchangeably be referred to as “link under test (LUT),” “fiber under test (FUT),” or “device under test (DUT).” In some examples, the LUT may be a point to point fiber optic link, while in other examples, the LUT may be a point to multi-point fiber optic link.

In some instances, an OTDR may be implemented on one end of the fiber optic cable to analyze returned light. Specifically, the OTDR may utilize Rayleigh backscattering and Fresnel reflections to monitor transmission characteristics. These characteristics may include, among other things, distances of transmission “events” along a link (e.g., connection points, fusion splices, fiber bends, etc.), and attenuation of signals during travel through the link.

To minimize the impact of errors and uncertainties that can accompany one-way testing of a fiber optic link, two-way reflectometry test methods may be utilized. That is, instead of implementing an OTDR on one end of a fiber optic link, two OTDRs may be connected on both ends of the fiber optic cable to improve the precision and accuracy of testing of a fiber optic link. The two OTDRs may each make a measurement separately and in sequence, and results from the two OTDRs may be combined to overcome the impact of differences in fiber backscatter coefficients on insertion loss measurements.

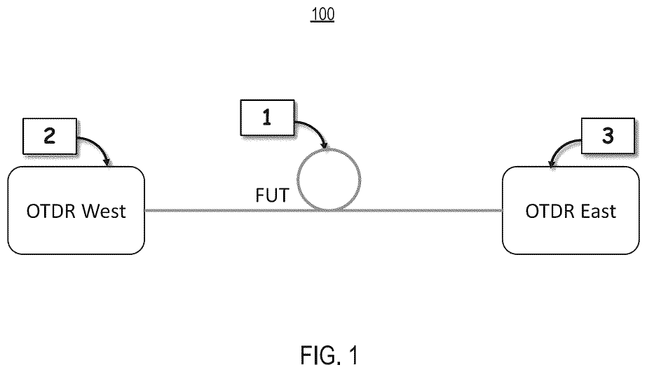

The two-way reflectometry test methods may also be referred to as “bidirectional” reflectometry testing, and may typically carried out over several wavelengths administered by the OTDRs. Typically, bidirectional OTDR measurements may be carried out on multi-fiber cables (or multi-core optical fiber cables), wherein optical switches may be used to automate measurement of each of the fibers by sequentially testing one fiber at a time. FIG. 1 illustrates a system 100 implementing bidirectional reflectometry testing between two optical time-domain reflectometers (OTDRs), according to an example. In FIG. 1, a fiber under test (FUT) 1 may be connected on a first end an OTDR (West) 2, and on a second end to an OTDR (East) 3.

It may be appreciated that, in between or after the generation of results from the two OTDRs, it may be desirable to exchange information related to the tests (e.g., data related to measurement such as results, measurement status, or control messages, etc.). However, in certain environments, like data centers, personal device (e.g., smartphones) may not be permitted, leaving few ways for service technicians to communicate.

One way to facilitate such exchange of information may be via implementation a communication line (e.g., a fiber optic link) dedicated transmission and exchange of information between the OTDRs. Users of the OTDRs (e.g., service technicians) located on either side may utilize the dedicated communication line to share messages. By way of example, a fiber optic link may be connected to a dedicated, additional port of each of the two OTDRS, and the information exchange may be facilitated by additional optical connectors on the OTDRs, and/or the addition of a specific hardware module.

It may be appreciated that, in some instances, implementation of an additional fiber may be complicated and burdensome. It may be more desirable to avoid use of an additional fiber, and instead to utilize the FUT as a transmission medium upon which to send exchange information related to tests conducted related to the FUT. In some instances, this may be referred to as a “same-fiber configuration.”

In a same-fiber configuration, time division multiplexing (TDM) may enable use of a single fiber (e.g., an FUT) for bi-directional measurement between OTDRs, and for exchange of various data between the OTDRs. By implementing TDM, certain time slots may be dedicated for OTDR measurement (or “acquisition”) periods, while other time slots may be dedicated for data exchange (e.g., test results data) between the OTDRs. For example, during a waiting period when a (first) OTDR may be waiting for a command to initiate testing, a FUT may be used to send a message from a first service technician (e.g., operating the first OTDR) to a second service technician (e.g., operating a second OTDR). As used herein, in certain situations, the terms “time slot” and “time period” may be used interchangeably, while in other situations, a time slot may denote a particular portion of a time period, depending on the context.

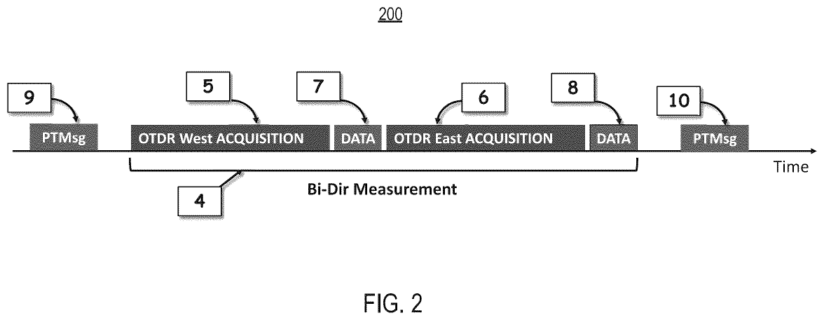

FIG. 2 illustrates a timespan 200 over which time division multiplexing (TDM) may enable bi-directional measurement and exchange of data between two OTDRs, according to an example. As discussed further below, TDM may be implemented to have measurement periods and data exchange periods be exclusive of each other.

In FIG. 2, a bidirectional measurement sequence 4 having multiple time periods for various operations is shown. Specifically, the bidirectional measurement period 4 may include a first acquisition period 5 for a first OTDR (OTDR West Acquisition), followed by a first data exchange period 7 (Data), wherein the results of the first acquisition may be exchanged between the first OTDR and a second (e.g., east) OTDR. Similarly, via implementation of TDM, the bidirectional measurement period 4 may include a second acquisition period 6 for the (e.g., east) OTDR (OTDR East Acquisition), followed by a second data exchange period 8 (Data), wherein the results of the first acquisition may be exchanged between the first OTDR and a second (e.g., east) OTDR.

The first acquisition period 5 may be preceded by a message period 9 (PTMsg), wherein a message (e.g., a predefined text message) between users of the first OTDR and a second (e.g., east) OTDR may be exchanged. Also, the second acquisition period 6 may be followed by a message exchange period 10 (PTMsg), wherein a message between users (e.g., service technicians) of the first OTDR and a second OTDR may be exchanged.

However, it may be apparent that messaging over TDM comes with certain limitations and inefficiencies. Unfortunately, as indicated in FIG. 2, messages 9, 10 may not be sent during the bidirectional measurement period 4, only before initiation or after completion. Specifically, messaging between users may be limited to before a (measurement) start command is launched, during a rest phase, or after a measurement has completed.

Since the exchange of messages may not be possible during acquisition periods 5, 6 or during data exchange periods 7, 8 of the bidirectional measurement period 4, users on either side of the link may be required to wait until the OTDRs are no longer active to exchange messages. In particular, messages may not be transmitted in between successive acquisitions or during switching from one fiber to another. Naturally, this may results in limiting necessary or desirable interactivity.

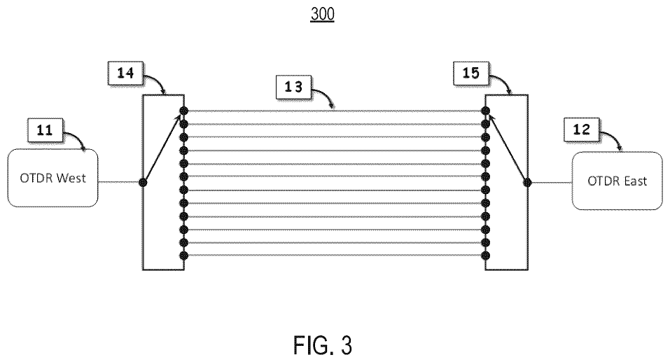

Furthermore, since bidirectional OTDR measurements are typically carried out on multi-fiber cables, a total (time) duration for measurement of these fibers may be substantial, and therefore may result in significant waiting times for exchange of messages between users. FIG. 3 illustrates a system 300 implementing a bidirectional reflectometry testing carried over a multi-fiber cable, according to an example. A bidirectional test is carried out on a FUT 13 having twelve (12) optical fibers (e.g., a “ribbon” cable). OTDR 11 (OTDR West) is connected to the FUT 13 by optical switch 14, and OTDR 12 (OTDR East) is connected to the FUT 13 by optical switch 15. During a multi-fiber bidirectional measurement, the optical switch 14 and the optical switch 15 enables moving from one fiber to another during testing.

Additional limitations are present as well. Typically, messaging between users located on either side of a link under test (LUT) may be limited to a defined number of predefined short messages to limit the volume of data to be transmitted. That is, because priority is given to time slots dedicated to measurement, since measurement can last from a few seconds to several minutes, and because messages may (only) be transmitted when measurement is not in progress, this may require limiting message size and message interactivity associated with TDM-based messaging. Accordingly, existing messaging solutions may typically only allow for a small number of minimal, pre-defined (e.g., text) messages to be exchanged, which can lead to confusion and ambiguity for users (e.g., service technicians).

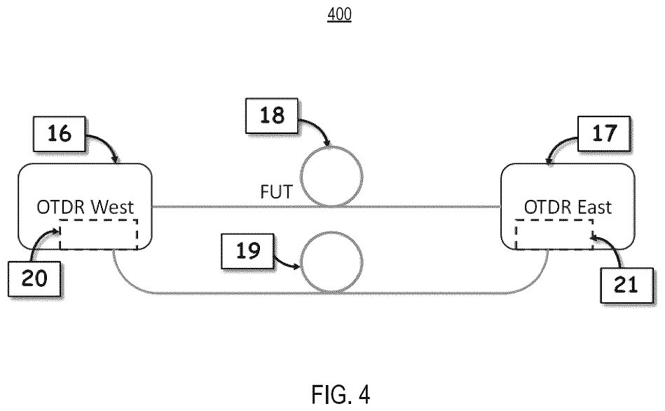

Furthermore, in addition to data messages, it may also be desirable exchange voice data over a LUT as well. For example, in certain situations, voice messages may be exchanged via connection of a second optical fiber (as discussed above) between a first and second OTDR. FIG. 4 illustrates a system 400 implementing a bidirectional reflectometry testing including a dedicated link for voice messaging, according to an example.

In FIG. 4, a first OTDR 16 (OTDR West) and a second OTDR 17 (OTDR East) may be coupled by an FUT 18, along with an additional optical fiber 19 dedicated to exchange of voice messages. In particular, the first OTDR 16 may include a voice messaging function 20 and the second OTDR 17 may include a voice messaging function 21 that may facilitate exchanging of voice messages over the additional optical fiber 19. However, by implementing the dedicated optical fiber, advantages in efficiency associated with same-fiber implementations are lost.

Accordingly, it may be appreciated that exchanging multimedia messages over a communication link in a non-limiting manner during testing and measurement in an efficient manner may be desirable. As used herein, “multimedia” may include messaging via one or more content formats, including text, audio (or voice), image, or video formats. Systems and methods described herein are directed to, among other things, multimedia messaging during (e.g., in between) bidirectional OTDR measurements using a fiber under test (FUT). In particular, as discussed in further detail below, systems and methods described herein may be implemented utilizing TDM-based techniques and without requiring any additional, dedicated fibers, and may facilitate communications that are not subject to limitations in size and quantity.

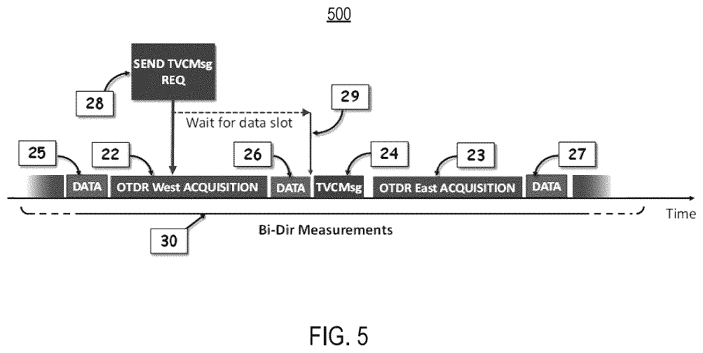

FIG. 5 illustrates a timespan 500 over which time division multiplexing (TDM) may enable bi-directional measurement and exchange of multimedia content between optical time-domain reflectometers (OTDRs), according to an example. FIG. 5 illustrates a bidirectional measurement sequence 30 having multiple time period (or time slots) for various operations.

Specifically, the bidirectional measurement period 30 may include a first acquisition period 22 for a first OTDR (OTDR West Acquisition), preceded by a first data exchange period 25 (e.g., for exchange of results data) (Data), and followed by a second data exchange period 26 (e.g., for results exchange) (Data). Also, the bidirectional measurement period 30 may include a second acquisition period 23 for a second OTDR (OTDR East Acquisition), which may be followed by a third data exchange period 27 (e.g., for results exchange) (Data).

At a certain time during the first acquisition period 22, a user (e.g., a service technician) may wish to, and may request 28 (Send TVCMsg Req), sending of a message. Using TDM, multimedia content, such as voice or text data, may be sent (e.g., via Internet Protocol (IP)) in between OTDR acquisitions. So, in some examples, during waiting of a messaging data slot (e.g., after completion of the first acquisition period 22 and second data exchange period 26), the message may be prepared. TDM may be utilized to determine a time slot 29 to send one or more messages 24 (TVCMsg) via the FUT (e.g., in between the first acquisition period 22 and (prior to) the second acquisition period 23). As such, one or more messages may be inserted while transitioning in between two acquisition sequences. In a similar manner, TDM may be utilized to determine one or more time slots to send one or more messages while transitioning between measurements of a first fiber of the FUT to measurement of a second fiber of the FUT.

As such, it may be appreciated that users may not be required to wait until completion of both ends of a bidirectional measurement to complete to send a message. Instead, the user may request sending of a message (e.g., via selection a request button on a user interface (UI)) during an OTDR acquisition, and may wait for a time slot to open (for example) while transitioning between a first acquisition and a second acquisition of a bidirectional measurement of a FUT, or (for example) in between measurements of one or more fibers of the FUT.

So, in some examples, if a user (e.g., a service technician) may initiate a communication (e.g., voice, message), sending of the message will not take priority over an (ongoing) OTDR acquisition, but instead may wait until end of the OTDR acquisition to be sent. In particular, in some examples, the one or more messages 24 may be sent in between two successive acquisition periods.

In some examples, it may be sent just after end of the and second data exchange period 26, while in some examples, it may be sent after the end of the bidirectional measurement period 30. It may be appreciated that, although the request 28 (Send TVCMsg Req) sending of a message may be illustrated taking place during the bidirectional measurement period 30, initiation of sending of the one or more messages 24 may take place any time after completion of the first acquisition period 22.

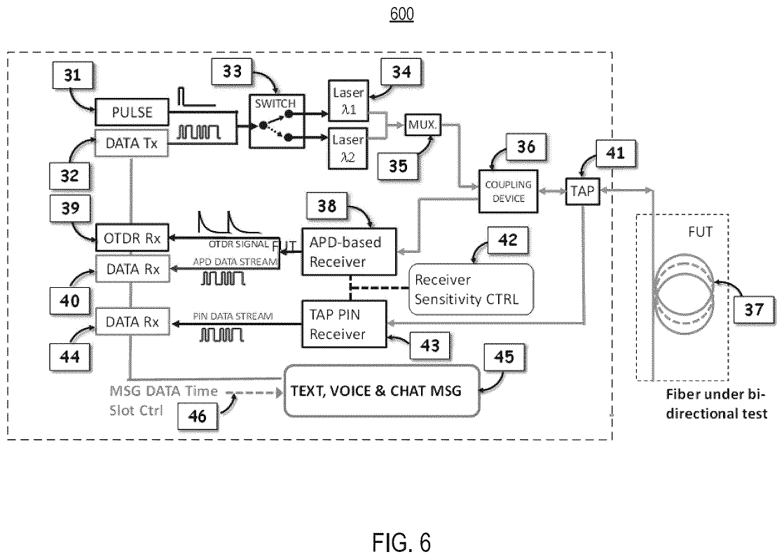

FIG. 6 illustrates aspects of an OTDR device 600 configured to utilizing TDM to enable bi-directional measurement and exchange of multimedia content, according to an example. In some examples, the OTDR device 600 may include a pulse generator 31 and a data transmitter 32. The pulse generator may be utilized to transmit acquisition signals, while the data transmitter 32 may be utilized to transmit messages.

Specifically, during transmission of a multimedia message, a time controller 46 may utilize TDM techniques to determine a time slot that may be made available for message transmission (e.g., in between a first acquisition period and a second acquisition period, or in between measurement of a first fiber of the FUT to a second fiber of the FUT). A message generation controller 45 may generate a message to be sent over the FUT 37. Upon determination of an appropriate time slot (via the aforementioned TDM techniques), the time slot information and message information may be received by the data transmitter 32, and the message may be transmitted over the FUT 37.

Moreover, depending on whether an acquisition signal or message signal is to be sent, an optical switch 33 may be utilized to switch between generation of the laser source 34 at wavelength λ1 (e.g., for acquisition) and a wavelength λ2 (e.g., for messaging). To reach an FUT 37, a (generated) laser may pass through wavelength multiplexer (mux) 35, optical coupler 36, and tap coupler 41. The mux 35 may, among other things, combine multiple optical signals for sending to the optical coupler 36 and the tap coupler 41, prior to sending over the FUT 37. In some examples, the OTDR 600 may also include a memory buffer that may be used to temporarily store message data before a time slot may become available.

In some examples, insertion of the message period may be managed by message generation controller 45 and a time controller 46, which may manage the timing of the TDM slots. In some examples, when the message generation controller 45 may receive authorization to send a message and a request may be in progress, the message generation controller 45 may be able to use the different functional blocks of the OTDR 600 to send the message. Thus, data of the message may be transmitted via the data transmitter 32, and the signal may then be sent to one of the two lasers via the switch 33. In some examples, the (selected) laser may send a modulated optical signal to the fiber under test via wavelength multiplexer (mux) 35, the optical coupler 36, and the tap coupler 41.

In some examples, voice messages may be sent via the Real-time Transport Protocol (RTP) network protocol for enabling Voice over Internet Protocol (VOIP) over the FUT 37. Also, in some examples, data (e.g., chat, text, etc.) messages may be sent via Standard Commands for Programmable Instruments (SCPI) standard (e.g., to signal call requests, call acceptance, call completion, and other control signals). It may be appreciated that, in addition to voice and text messages, other protocols and standards may be utilized to send a variety content media, such video and other file types, over the FUT 37.

During receipt of an optical signal transmitted over the FUT 37, a signal may pass through the tap coupler 41, where it may be passed to receiver sensitivity controller 42. The receiver sensitivity controller 42 may facilitate transmission over one of two paths. The first path may be to and through an avalanche photodiode receiver 38, while the second path may be to and through a tap pin receiver 43. The optional determination of whether to send over the first path or the second path may be a function of the power optics characteristics during reception. In the event of a (more favorable) optical coupling ratio, the first path may be used. In more limited instances, the second path may be used, as use of the first path may limit impact on measurement dynamics of the OTDR device 600 and the sensitivity of data reception via the (APD)-based receiver 38. In some examples, the TAP coupler 41 may be a (relatively) unbalanced optical coupler which may (i.e., for a “high coupling ratio”) output a majority of the optical power received from the LUT on the first path dedicated to cases of low received power, and may output (i.e., for a “low coupling ratio”) a remainder of the optical power received from the LUT on the second path dedicated to cases of where high(er) optical power allotments may be received.

In some examples, the APD based receiver 38 may be more effective than the PIN receiver 43 for low(er) power signatures, on the other hand the PIN receiver 43 may be more effective for high(er) power signatures. In some examples, the tap coupler 41 may transmit a first portion (e.g., ninety-five percent (95%)) of the signal received from the LUT to be sent towards the APD based receiver 38, and a second portion (e.g., five percent (5%)) of the signal received from the LUT to be sent towards the PIN receiver 43. When signals that may be received may be weak, they may be attenuated by the tap coupler 41. When signals may be too strong for the APD based receiver 38, they may be attenuated by the tap coupler 41 and then directed towards the data receiver 44.

Specifically, in some examples, when receiving an optical signal transmitted on the FUT 37, a signal may pass through two separate paths. In some examples, a first path may be through the high coupling ratio output of the tap coupler 41 where it can be transmitted to the optical coupler 36 then to the APD based receiver 38, and a second path that may be through the low coupling ration output of the tap coupler 41 where it can be transmitted to the PIN receiver 43. The selection of one of the two paths may be carried out via the receiver sensitivity controller 42, which may utilize the signals received on the data receiver and data receiver 44 to favor the channel offering the best performance. In some instances, the optical power level may depend on, among other things, the power emitted at the other end of the link (e.g., by the second OTDR), the optical attenuation of the LUT (also referred to as “link optical budget”), and the insertion loss of the optical components at the input of the OTDR (e.g., the TAP coupler 41).

In some examples, the optical link budget may generally depend on a length of the optical LUT and the insertion part of the elements constituting the link such as the optical connections or optical couplers. In case of high optical budget, the power received by the OTDR may be low and a first path based on APD can be used. In cases of low link optical budget, in cases of greater optical power, the second path can be used, because use of the first path may limit the impact on the measurement dynamics of the OTDR device 600 and the sensitivity of data reception via the avalanche photodiode receiver 38. Typically, the second path may be utilized in the case of higher optical power signals, as it may be inherently less sensitive to insertion loss(es) associated with the LUT optical budget and the insertion loss of the optical tap coupler 41. Specifically, in some instances, an avalanche photodiode receiver 38 may become over-saturated due to insufficient budget loss (e.g., if OTDRs being tested are too close together), and may be unable to decode the incoming signal. On the other hand, the tap PIN receiver 43 may be configured to operate at lower sensitivities, and may be able to decode signals incoming with relatively higher power throughputs. As such, the tap coupler 41 and a receiver sensitivity controller 42 may facilitate selection of a (appropriate) channel depending on such power constraints, and may pass (some or all of) the received signal to the avalanche photodiode receiver 38 and the tap PIN receiver 43. OTDR data (e.g., results data) may be received and decoded from the avalanche photodiode receiver 38 at OTDR receiver 39, and message data (e.g., voice data) may be received and decoded (e.g., for playback or display) from the avalanche photodiode receiver 38 at data receiver 40. Also, message data (e.g., voice data) may be received and decoded from the tap PIN receiver 43 at data receiver 44.

Accordingly, in this manner, voice and data messages may be sent by the time controller 46 and the message generation controller 45 in between OTDR acquisitions without waiting for an entire bidirectional measurement to be completed. Instead, sending of messages may be made available during bidirectional measurement, and users (e.g., service technicians) present on both sides of a communication link under test may not be required to wait for their respective OTDRs to be inactive to send messages.

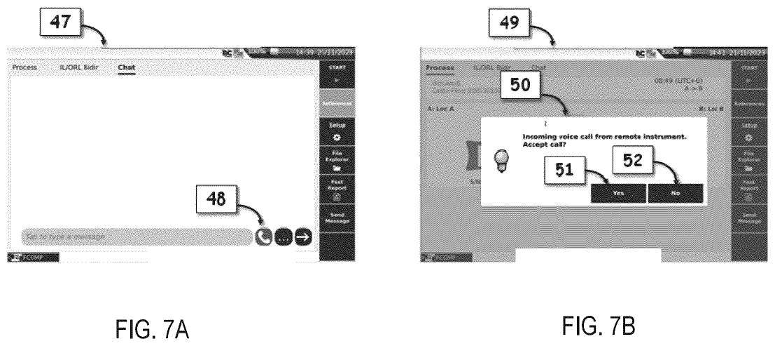

FIGS. 7A-7B illustrates a pair of user interfaces (UIs) implemented by an OTDR device (e.g., the OTDR device 600) in association with bi-directional measurement and exchange of multimedia content, according to an example. FIG. 7A illustrates a first OTDR device interface 47, wherein a message sending function may include a text entry bar to enter a test message, and a voice call initiation button 48 to enable transmission of a voice message. FIG. 7B illustrates a second OTDR device interface 49, wherein a pop-up message 50 may inform a user that a voice call may be incoming, and UI buttons 51, 52 may enable the user to accept or deny the voice call.

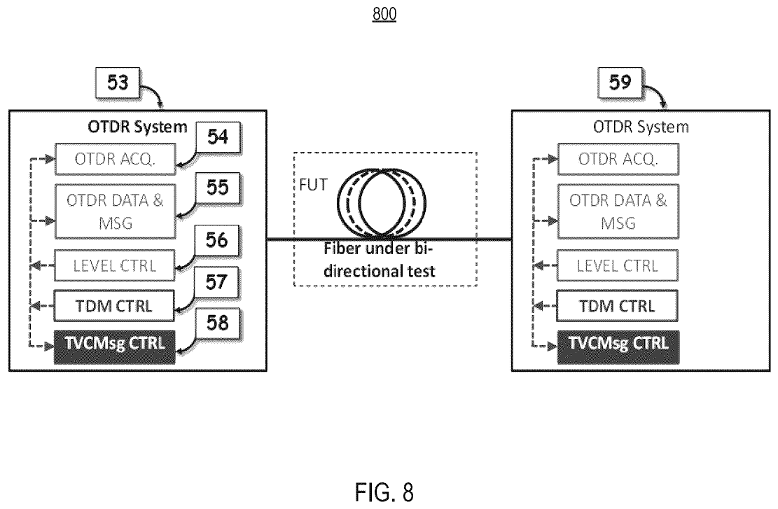

FIG. 8 illustrates a system 800 including a pair of OTDRs configured to utilizing TDM to enable bi-directional measurement and exchange of multimedia content, according to an example. FIG. 8 illustrates a first OTDR 53 coupled to a second OTDR 59 by a FUT. In some examples, the first OTDR 53 may include various components, including a power supply, a display, and a storage medium (not shown). In addition, the first OTDR 53 may include an acquisition block 54 that may be used to perform an acquisition during a bidirectional measurement, and a data exchange block 55 that may be used to exchange OTDR data (e.g., test results, messages, etc.) with the second OTDR 59.

In addition, the first OTDR 53 may include a level controller block 56 that may be implemented to choose an acquisition chain (e.g., of higher or lower sensitivity), depending a level of optical power associated with/during receiving of data (as discussed above). The first OTDR 53 may also include a TDM block 57 that may manage issuance of different time slots via TDM techniques (e.g., for acquisition, data exchange, sending of messages, etc.), as discussed above. The first OTDR 53 may further include a message control block 58 that may control sending and receipt of multimedia messages (e.g., files, text, voice, etc.) by the first OTDR 53 over the FUT.

It may be appreciated that while it may be advantageous to exchange information related to tests in between or after the generation of results of bidirectional reflectometry testing, it may also be beneficial to send messages in real-time during any time of bidirectional reflectometry testing. Systems and methods described herein may further be directed to, among other things, real-time multimedia messaging at any time during bidirectional OTDR measurements using a fiber under test (FUT). In particular, as discussed in further detail below, systems and methods described herein may also be implemented utilizing TDM-based and wavelength division multiplexing (WDM)-based techniques to facilitate real-time multimedia messaging without limitation of size and quantity, and without requiring any additional, dedicated fibers for communication.

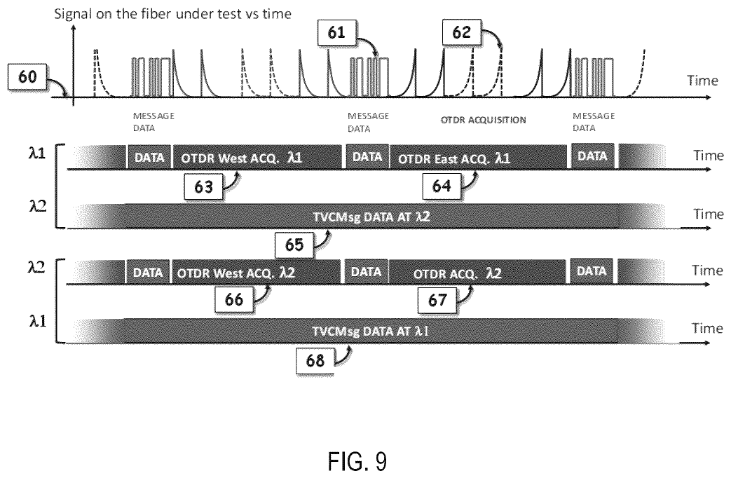

FIG. 9 illustrates a timespan over which TDM and wavelength division multiplexing (WDM) enable bi-directional measurement and exchange of multimedia content data, according to an example. In particular, FIG. 9 describes a plurality of sequences in time and frequency domains that may be implemented to enable real-time sending of multimedia messages during bidirectional reflectometry testing.

As discussed further below, in some examples, the systems and methods described herein may implement TDM and WDM techniques to implement a first set of one or more wavelengths for bidirectional reflectometry testing, and a second set of one or more wavelengths for communication (e.g., voice, text, etc.). More particularly, in some examples, as a result of implementing TDM and WDM techniques in tandem, time periods associated with exchange of measurement and results data for bidirectional reflectometry testing may be independent of and may no longer impacted by time periods that may be allocated for messaging.

In some examples, WDM may be utilized to switch between a first wavelength λ1 and second wavelength λ2, and TDM may be utilized to allocate time slots between acquisition phases and results data exchanges phases of a bidirectional measurement. In some examples, over a time period 60, TDM and WDM techniques may be utilized to facilitate a first acquisition (West) 63 and a second acquisition (East) 64 (e.g., as indicated with signal activity 62), including results data exchange(s) (e.g., as indicated with signal activity 61) using the first wavelength λ1. In addition, WDM techniques may be utilized to implement a second wavelength λ2 to facilitate communication 65 between the OTDRs, for example, on a continuing basis and in real-time.

That is, WDM may be utilized to implement a frequency “swap”, wherein a first wavelength (previously) used for a first purpose may be used for a second purpose, and a second wavelength used for the second purpose may be used for the first purpose. Specifically, in some examples, WDM techniques may designate the second wavelength λ2 for a bidirectional measurement, wherein a first acquisition (West) 66 and a second acquisition (East) 67, including results data exchange(s) may be facilitated using the first wavelength λ2. As discussed above, TDM may be utilized to allocate time slots between the acquisition phases and the results data exchange phases of the bidirectional measurement. In addition, WDM techniques may be utilized to implement the first wavelength λ1 to facilitate communication 68 between the OTDRs. Similar to the examples discussed above, the communication 65 of multimedia content may be facilitated using internet protocol (IP).

Accordingly, in some examples, the systems and methods provided herein may combine TDM and WDM techniques to facilitate OTDR functions (e.g., measurement, data transfer, etc.) along with non-limited, advanced communication functions in real-time (e.g., via a dedicated wavelength). Examples of such non-limited, advanced real-time communications that may have been previously unavailable may include instant messaging (IM), chat (i.e., sending of multiple messages back-and-forth on a continuing basis), real-time voice messaging, along with sending and receiving of data files of non-limited sizes.

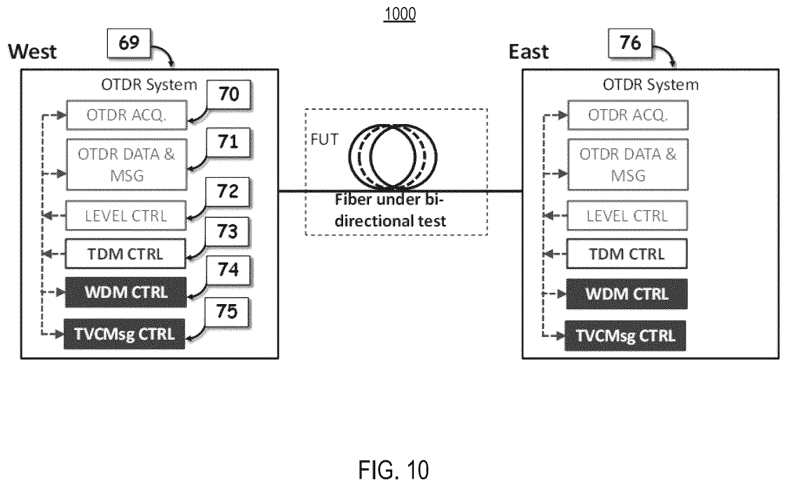

FIG. 10 illustrates of a system 1000 including a pair of OTDRs utilizing TDM and WDM to enable bi-directional measurement and exchange of multimedia content data over an FUT, according to an example. In some examples, a first OTDR 69 may include various components, including a power supply, a display, and a storage medium (not shown). The first OTDR 69 may include an acquisition block 70 that may be used to perform an acquisition during a bidirectional measurement, and a data exchange block 71 that may be used to exchange data (e.g., test results, etc.) associated with a bidirectional measurement with a second OTDR 76.

In addition, the first OTDR 69 may include a level controller block 72 to choose an acquisition chain (e.g., of higher or lower sensitivity), depending a level of optical power associated with/during receiving of data. The first OTDR 69 may also include a TDM block 73 that may manage allocation of different time slots via TDM techniques (e.g., for acquisition, data exchange, sending of messages, etc.). The OTDR 69 may also include a WDM management block 74 for managing wavelength multiplexing to switch between measurements and messaging functionalities of the OTDR 69. Furthermore, the OTDR 69 may include a message exchange block 75 that may facilitate sending and receipt of messages (e.g., files, text, voice, etc.) over the FUT between a first user (e.g., a service technician) of the first OTDR 69 to a second user of the second OTDR 76.

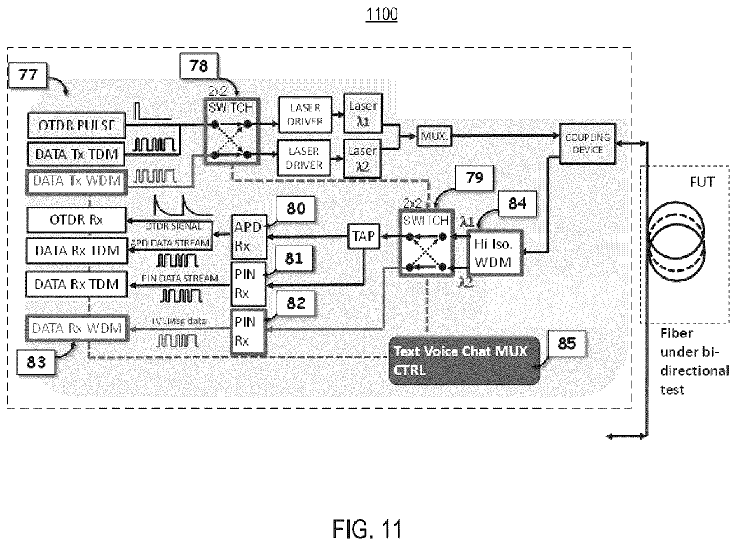

FIG. 11 illustrates aspects of an OTDR device 1100 to utilize TDM and WDM techniques to enable bi-directional measurements and exchange of multimedia content, according to an example. In some examples, the OTDR device 1100 may enable switching between multiple wavelengths via implementation one or more switches (e.g., electrical switches, optical switches). It may be appreciated that, in some examples, use of WDM technology may require use of dual or multi-wavelength OTDRs. For examples, in some examples, bidirectional OTDR measurements may typically carried out using two or three wavelengths.

For example, the OTDR device 1100 may include an electrical switch 78 that may be implement to switch between optical signals of a first wavelength λ1 and a second wavelength λ2. In particular, in some examples, the switch (e.g., when “open”) may implement a first laser driver to generate a first optical signal (e.g., laser) at wavelength λ1 for OTDR acquisition (i.e., measurement) and data exchange, and a second laser driver to generate a second optical signal at wavelength λ2 for communication/messaging (e.g., in real-time). Conversely, in some examples, the switch 78 (e.g., when “closed”) may utilize wavelength λ1 for communication/messaging and wavelength λ2 for acquisition and data exchange. As discussed further below, the switch 78 may be controlled by messaging (mux) controller 85, which may facilitate utilization of TDM and WDM techniques to enable propagation of (outgoing) signals associated with bi-directional measurements and exchange of multimedia content between OTDRs.

The OTDR device 1100 may also include a switch 79 that may be used to switch optical signals between a first wavelength λ1 and a second wavelength λ2. In particular, in some examples, the switch 79 may receive signals at wavelength λ1 for OTDR acquisition (i.e., measurement) and data exchange, and may receive signals at a second wavelength λ2 for communication/messaging (e.g., in real-time). In some examples, the switch 79 may be controlled by messaging controller 85.

By way of example, during acquisition, an OTDR pulse transmitter may enable the (e.g., electrical) switch 78 to cause a laser driver to generate an optical signal at first wavelength (e.g., λ1), which may be propagated through a mux and a coupling device for transmission over the FUT to an opposite OTDR. In some examples, the OTDR pulse transmitter, like the switch 78, may be coupled to the messaging controller 85.

Similarly, during OTDR data exchange (e.g., OTDR results data), a data transmitter may enable the (e.g., electrical) switch 78 to cause a laser driver to cause through a laser driver, a laser to generate an optical signal at first wavelength (e.g., λ1), and may be propagated through a mux and a coupling device for transmission over the FUT to an opposite OTDR. In some examples, the data transmitter, like the switch 78, may be coupled to the messaging controller 85.

For messaging (i.e., sending of a multimedia message), a data transmitter may enable the electrical switch 78 to cause through a laser driver, a laser to generate an optical signal at second wavelength (e.g., λ2), and may be propagated through the mux and the coupling device to the FUT for transmission to an opposite OTDR. In some examples, the data transmitter, like the switch 78, may be coupled to the messaging controller 85.

### Same Note

During receipt of (incoming) signals sent from an (opposing) OTDR, for an OTDR acquisition and data exchange signal at wavelength λ1, a switch 79 may receive the signal incoming from an FUT, and may connect to OTDR and TDM data receivers (e.g., via APD 80 or PIN 81). As discussed above, the connection may be made depending on sensitivities associated with power characteristics of the (incoming) signal. In addition, a (high isolation) wavelength demultiplexer (demux) 84 may be implemented to differentiate signals received wavelengths λ1 and λ2, and to ensure that receipt of signals having the two (different) wavelengths λ1 and λ2 do not cause interference. In some examples, the OTDR and TDM data receivers, like the switch 78, may be coupled to the messaging controller 85.

For messaging (i.e., receipt of a multimedia message), the switch 79 may propagate the signal to PIN 82 and the WDM data receiver 83. In some examples, the switches 79 may be controlled by the multiplexer controller 85. In some examples, the WDM data receiver, like the switch 78, may be coupled to the messaging controller 85.

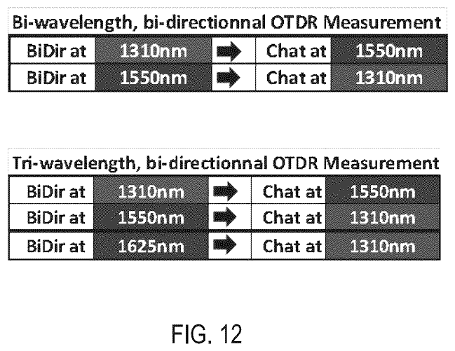

FIG. 12 provides proposed wavelengths that may be implemented via wave division multiplexing (WDM) during single-mode fiber bidirectional reflectometry testing, according to an example. As discussed above, in some examples, a first wavelength that may be used for OTDR measurement and OTDR data exchanges may need to be different from a second wavelength that may be used for communication/messaging purposes. In a first example utilizing two different wavelengths, if bidirectional measurements may take place at thirteen hundred ten (1310) nanometers (nm), then communication/messaging may take place at fifteen hundred fifty (1550) nanometers (nm). Conversely, if bidirectional measurements and data exchanges may take place at fifteen hundred fifty (1550) nanometers (nm), then communication/messaging may take place at thirteen hundred ten (1310) nanometers (nm).

In a second example where bidirectional measurement and data exchanges may be carried out using three wavelengths, the bidirectional measurements may take place at thirteen hundred ten (1310) nanometers (nm), and the communication/messaging may take place at fifteen hundred fifty (1550) nanometers (nm), or the bidirectional measurements and data exchanges may take place at fifteen hundred fifty (1550) nanometers (nm), and the communication/messaging may take place at thirteen hundred ten (1310) nanometers (nm). With regard to the use of a wavelength at sixteen hundred twenty-five (1625) nanometers (nm), it may be suitable to use this wavelength for the bidirectional measurements and data exchanges with a paired wavelength of thirteen hundred ten (1310) nanometers (nm) for communication/messaging (and not fifteen hundred fifty (1550) nanometers (nm)) because the relatively small difference in wavelengths between the use of sixteen hundred twenty-five (1625) nanometers (nm) and fifteen hundred fifty (1550) nanometers (nm) may create signal interference due to non-linear effects associated with the Raman phenomenon. Accordingly, in this manner, the system and methods described herein, whether using TDM techniques or TDM techniques in combination with WDM techniques, may enable communication between OTDR operators wherein communications by other means may be limited or prohibited.

Systems and methods provided herein may include a method for communicating during bidirectional testing of a fiber optic link under test (LUT), comprising initiating a bidirectional measurement of the LUT, including initiating a first acquisition by a first optical time domain reflectometer (OTDR), receiving a request, prior to completion of the bidirectional measurement of the LUT, to send a multimedia message over the LUT during the bidirectional measurement of the LUT, receiving information related to the multimedia message to be sent, preparing the multimedia message to be sent over the LUT, determining a time slot during the bidirectional measurement of the LUT to send the multimedia message, and sending the multimedia message during the time slot over the LUT to a second OTDR. In some examples, the time slot during the bidirectional measurement of the LUT is upon completion of the first acquisition by the first OTDR and prior to initiation of a second acquisition by the second OTDR, and the time slot during the bidirectional measurement of the LUT is upon completion of the first acquisition by the first OTDR and completion of an exchange of results of the first acquisition between the first OTDR and the second OTDR. In some examples, the LUT is a multi-fiber cable including a plurality of fibers, the time slot during the bidirectional measurement of the LUT is in between testing of a first fiber of the plurality of fibers and testing of a second fiber of the plurality of fibers, the multimedia message includes one or more of voice, text, and chat data, and the time slot is determined using time-domain multiplexing (TDM).

In some examples, the systems and methods described herein may include an apparatus to conduct bidirectional testing of a fiber optic link under test (LUT), comprising a processor, a display to display information related to a bidirectional measurement of the LUT, a memory to store machine readable instructions executable by the processor, a pulse generator to generate an optical signal for propagation over the LUT to initiate a first acquisition associated with the LUT, a time controller to determine a time slot during the bidirectional measurement of the LUT to send a multimedia message, and a message generation controller to receive information related to the multimedia message, prepare the multimedia message to be sent over the LUT, send the multimedia message to a data transmission component for transmission over the LUT during the time slot. In some examples, the apparatus may further include a data receiver component to receive, over the LUT, one or more of an acquisition signal sent from a second OTDR, acquisition results data sent from the second OTDR, and a multimedia message received from the second OTDR. In some examples, the time slot during the bidirectional measurement of the LUT is upon completion of the first acquisition associated with the LUT and prior to initiation of a second acquisition associated with the LUT, the LUT is a multi-fiber cable including a plurality of fibers, the time slot during the bidirectional measurement of the LUT is in between testing of a first fiber of the plurality of fibers and testing of a second fiber of the plurality of fibers. In some examples, the multimedia message includes one or more of voice, text, and chat data, and the time slot is determined using time-domain reflectometry (TDM).

In some examples, the systems and methods may further include a method for communicating during bidirectional testing of a fiber optic link under test (LUT), the method comprising implementing a first wavelength to initiate a bidirectional measurement of the LUT, including initiating a first acquisition by a first optical time domain reflectometer (OTDR), receiving a request, prior to completion of the bidirectional measurement of the LUT, to send a multimedia message over the LUT during the bidirectional measurement of the LUT, determining a second wavelength to utilize for sending the multimedia message over the LUT, implementing the second wavelength to send the multimedia message in real-time over the LUT to a second OTDR. In some examples, the multimedia message is sent via Internet Protocol (IP), the first wavelength and the second wavelength are implemented via wavelength-division multiplexing (WDM), and the multimedia message includes one or more of voice, text, and chat data. Also, in some examples, the first acquisition by the first OTDR occurs in a first time slot, and a results exchange of the first acquisition occurs in a second time slot, and wherein the first time slot and the second time slot are determined via time-domain multiplexing (TDM), and the LUT is a multi-core optical fiber.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. A method for communicating during bidirectional testing of a fiber optic link under test (LUT), comprising:
initiating a bidirectional measurement of the LUT, including initiating a first acquisition by a first optical time domain reflectometer (OTDR);
receiving a request, prior to completion of the bidirectional measurement of the LUT, to send a multimedia message over the LUT during the bidirectional measurement of the LUT;
receiving information related to the multimedia message to be sent;
preparing the multimedia message to be sent over the LUT;
determining a time slot during the bidirectional measurement of the LUT to send the multimedia message; and
sending the multimedia message during the time slot over the LUT to a second OTDR.

2. The method of claim 1, wherein the time slot during the bidirectional measurement of the LUT is upon completion of the first acquisition by the first OTDR and prior to initiation of a second acquisition by the second OTDR.

3. The method of claim 1, wherein the time slot during the bidirectional measurement of the LUT is upon completion of the first acquisition by the first OTDR and completion of an exchange of results of the first acquisition between the first OTDR and the second OTDR.

4. The method of claim 1, wherein the LUT is a multi-fiber cable including a plurality of fibers.

5. The method of claim 4, wherein the time slot during the bidirectional measurement of the LUT is in between testing of a first fiber of the plurality of fibers and testing of a second fiber of the plurality of fibers.

6. The method of claim 1, wherein the multimedia message includes one or more of voice, text, and chat data.

7. The method of claim 1, wherein the time slot is determined using time-domain multiplexing (TDM).

8. An apparatus to conduct bidirectional testing of a fiber optic link under test (LUT), comprising:
a processor;
a display to display information related to a bidirectional measurement of the LUT;
a memory to store machine readable instructions executable by the processor;
a pulse generator to generate an optical signal for propagation over the LUT to initiate a first acquisition associated with the LUT;
a time controller to determine a time slot during the bidirectional measurement of the LUT to send a multimedia message; and
a message generation controller to:
receive information related to the multimedia message;
prepare the multimedia message to be sent over the LUT; and
send the multimedia message to a data transmission component for transmission over the LUT during the time slot.

9. The apparatus of claim 8, further comprising:
a data receiver to receive, over the LUT, one or more of an acquisition signal sent from a second OTDR, acquisition results data sent from the second OTDR, and a multimedia message received from the second OTDR.

10. The apparatus of claim 8, wherein the time slot during the bidirectional measurement of the LUT is upon completion of the first acquisition associated with the LUT and prior to initiation of a second acquisition associated with the LUT.

11. The apparatus of claim 8, wherein the LUT is a multi-fiber cable including a plurality of fibers.

12. The apparatus of claim 11, wherein the time slot during the bidirectional measurement of the LUT is in between testing of a first fiber of the plurality of fibers and testing of a second fiber of the plurality of fibers.

13. The apparatus of claim 8, wherein the multimedia message includes one or more of voice, text, and chat data.

14. The apparatus of claim 8, wherein the time slot during the bidirectional measurement of the LUT is determined using time-domain reflectometry (TDM).

15. A method for communicating during bidirectional testing of a fiber optic link under test (LUT), the method comprising:
implementing a first wavelength to initiate a bidirectional measurement of the LUT, including initiating a first acquisition by a first optical time domain reflectometer (OTDR);
receiving a request, prior to completion of the bidirectional measurement of the LUT, to send a multimedia message over the LUT during the bidirectional measurement of the LUT;
determining a second wavelength to utilize for sending the multimedia message over the LUT; and
implementing the second wavelength to send the multimedia message in real-time over the LUT to a second OTDR.

16. The method of claim 15, wherein the multimedia message is sent via Internet Protocol (IP).

17. The method of claim 15, wherein the first wavelength and the second wavelength are implemented via wavelength-division multiplexing (WDM).

18. The method of claim 15, wherein the multimedia message includes one or more of voice, text, and chat data.

19. The method of claim 15, the first acquisition by the first OTDR occurs in a first time slot, and a results exchange of the first acquisition occurs in a second time slot, and wherein the first time slot and the second time slot are determined via time-domain multiplexing (TDM).

20. The method of claim 15, wherein the LUT is a multi-core optical fiber.
